(19) United States
(12) Patent Application Publication
(10) Pub. No.: US 2014/0207563 A1
(43) Pub. Date: Jul. 24, 2014

(54) Method and Apparatus for Advertisement Screening

(71) Applicant: FORD GLOBAL TECHNOLOGIES, LLC, Dearborn, MI (US)

(72) Inventors: Yimin Liu, Ann Arbor, MI (US); Perry Robinson MacNeille, Lathrup Village, MI (US); Oleg Yurievitch Gusikhin, West Bloomfield, MI (US)

(73) Assignee: FORD GLOBAL TECHNOLOGIES, LLC, Dearborn, MI (US)

(21) Appl. No.: 13/744,659

(22) Filed: Jan. 18, 2013

(51) Int. Cl. G06Q 30/02

(52) U.S. Cl. CPC G06Q 30/0244
USPC 705/14.43

(57) ABSTRACT

A system includes a processor configured to initiate a new user-model for advertising evaluation based on a user request. The processor is also configured to add basic user demographic information to the model. The processor is further configured to update the model based on user responses to advertisements presented during a drive in which the model is in use and utilize the model to filter or select advertisements in drives having some correspondence to identifying traits associated with the model.

### TECHNICAL FIELD

The illustrative embodiments generally relate to a method and apparatus for advertisement screening.

### BACKGROUND

Various methods of advertisement selection and screening have been prosposed. These methods include:

U.S. 2009/0076915, which is generally directed at methods for providing advertisements using one or more vehicles, which comprise producing an advertisement for a vehicle and selecting a vehicle for the advertisement. The vehicle is selected that has a profile that corresponds to the advertisement profile. The present invention also provide systems and storage media for implementing the methods. With the methods, systems, and/or media, micro-targeted mobile advertising can be provided.

U.S. 2007/0113243, which generally relates to a targeted advertising system comprising an interface unit configured to receive broadcast transmissions, a primary broadcast stream for broadcast programming, a secondary broadcast stream for targeted advertising content, and a storage device for storing the targeted advertising content. The method comprises presenting a targeted advertising content to a user including receiving a primary broadcast stream, receiving a secondary broadcast stream, storing a portion of the secondary broadcast stream in a storage device, and presenting a targeted advertising stream to the user, which may be selected based on a user parameter.

U.S. 2004/0192351, which generally relates to context-relevant proximity-driven mobile advertising is accomplished by displaying advertisement content at display devices associated with mobile vehicles based on the context of the vehicles, such as location and time. An advertising context module associates plural advertisement contents with selected contexts. An advertising display controller associated with each vehicle uses a location provided by a locator device, such as a GPS locator, to determine a vehicle context and applies the context to select advertisement content for display at the vehicle.

### SUMMARY

In a first illustrative embodiment, a system includes a processor configured to initiate a new user-model for advertising evaluation based on a user request. The processor is also configured to add basic user demographic information to the model. The processor is further configured to update the model based on user responses to advertisements presented during a drive in which the model is in use and utilize the model to filter or select advertisements in drives having some correspondence to identifying traits associated with the model.

In a second illustrative embodiment, a computer-implemented method includes initiating a new user-model for advertising evaluation based on a user request. The method also includes adding basic user demographic information to the model. The method further includes updating the model based on user responses to advertisements presented during a drive in which the model is in use and utilizing the model to filter or select advertisements in drives having some correspondence to identifying traits associated with the model.

In a third illustrative embodiment, a non-transitory computer-readable storage medium stores instructions that, when executed by a processor, cause the processor to perform a method including initiating a new user-model for advertising evaluation based on a user request. The method also includes adding basic user demographic information to the model. The method further includes updating the model based on user responses to advertisements presented during a drive in which the model is in use and utilizing the model to filter or select advertisements in drives having some correspondence to identifying traits associated with the model.

### BRIEF DESCRIPTION OF THE DRAWINGS

FIG. 1 shows an illustrative vehicle computing system;

FIG. 2 shows an illustrative process for obtaining user preferences;

FIG. 3 shows an illustrative process for obtaining user data;

FIG. 4 shows an illustrative exemplary system usable for indexing advertisement information;

FIG. 5 shows an exemplary process for selecting advertisements; and

FIG. 6 shows an exemplary process for presenting advertisements and tracking user reactions.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

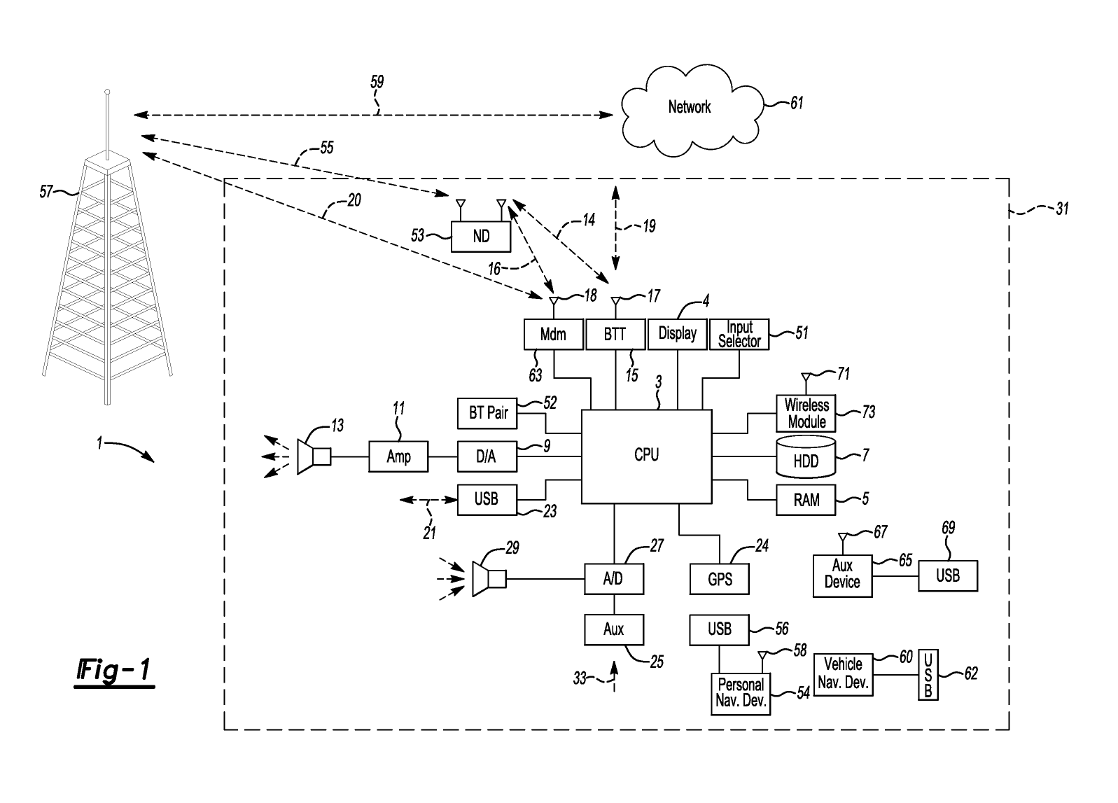

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Currently, all kinds of audio advertisements are played on radio programs, TV and mobile application, both in automotive contexts and during in-home enjoyment. Most of these advertisements, while possibly targeted at a specific group, are not deliverable in a specific sense with respect to the viewers, and can only be targeted based on the programming (i.e., the demographics known to watch a particular show/listen to a particular station).

Pandora radio and similar applications allow vehicle occupants several ways to control what songs are played, but provide little to no control over advertisements. An informational filter using a model-based recommender system suggests and plays back songs based on previously known driver preferences. Driver responses to music playback can be used for supervised training of Pandora's learning system. Although the content is changed based on driver preferences, there is no current usage of this information to alter advertisement playback or content.

The profiles of drivers and consumer information that travels through the vehicle systems can greatly improve the effectiveness and utility of advertising. According to vehicle types, routes, locations, and other known data, new markets for advertising and survey sampling can be opened. The illustrative systems discussed herein, can recommend more context aware advertisements and make the advertisements more relevant and targeted to drivers.

Although it's possible to use feedback information to determine advertisements, but it is desirable to anonymize the information before exposure to third parties to prevent reverse engineering of vehicle networks and compromising vehicle safety and/or passenger privacy.

A gatekeeper application could be implemented to address the desires to filter the data and protect the data from outside sources. The application could recommend advertisements, gather data, sample survey and, based on feedback from consumers, adjust future advertisement recommendations. The system can involve cloud-based computing and can use cloud resources to manage various aspects thereof.

The illustrative embodiments present methodologies for targeting advertisements towards vehicle occupants, using user data, route data, location data and trip-purpose data. Advertising can be targeted to serve the purposes of vehicle OEMs and/or application providers, to ensure consumer loyalty and satisfaction, and to differentiate between products and provide vital information to vehicle occupants.

A vehicle computing system can target advertisements based on software components provided as part of the VCS, such as, for example, onboard control applications, a recommender system that learns preferences and stores/updates them in a model, a policy server, and a rich media server. Data relating to occupants' preferences for advertisements, products, coupons and locations could be collected during their driving could be captured through the VCS.

Information for training the recommender system user model comes from information about an advertisement, data acquired at the point of purchase, explicit user input (using, for example, a spoken dialogue system), data collected from vehicle sensors, user reactions to previous advertisements, data collected from user surveys, etc.

The data mining function in the system searches the ad server for advertisements that are a good match with a user data model. Market basket analysis can be used to refine the list based on advertisements played in the recent past. Lists of matches from the data mining system are used to fetch advertisements from the ad server. The rich media player then presents the list of advertisements to the driver and the user selects one or more advertisements to play. The advertisements can include rich media ads that allow the user choices such as whether to accept a coupon, to get more information, purchase online, etc.

Consumers can be separated/clusters by demographic information, such as income, age, vehicles, purchase habits, etc. Then, within each group, drivers could be ranked in order of their probability to respond to advertising or special promotions of different products.

Based on the information, machine learning methods can be used to rank customers in order of their probability to respond to an ad. Once the users have been assigned to clusters, proper advertisements that fit user profiles can be delivered. User feedback can then be used to update preferences for clusters, and more accurate advertisement delivery can be obtained.

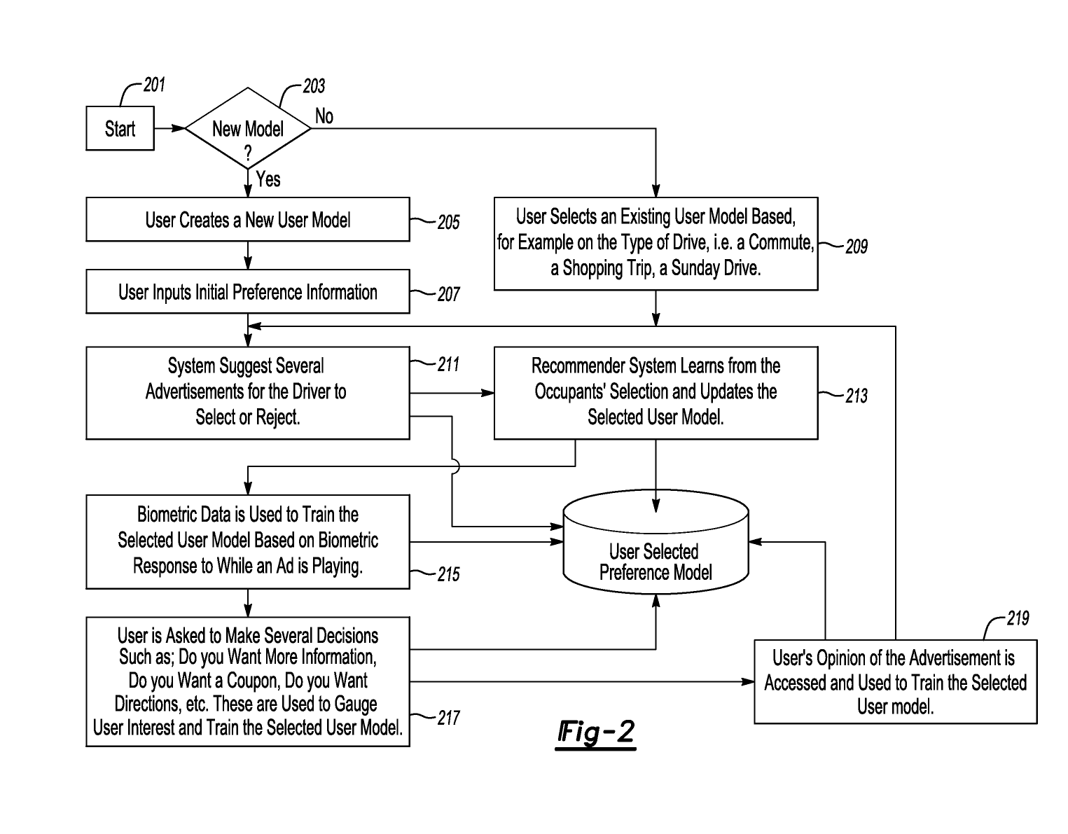

FIG. 2 shows an illustrative process for obtaining user preferences. In this illustrative example, the user may create one or more models relating to types of drives, user profiles, times of day, etc. In this example, the model creation process begins 201 and queries the user as to whether a new model is going to be created 203.

If a new user model isn't going to be created, the process may select an existing model for further training 209. This model could be based on user input, on a designated destination, on a time of day, etc. Otherwise, the model could be a new model 205 and could have one or more attributes associated therewith, such as time of day, destination, user profile, etc. The user could input additional initial preference information as well 207. This information can correspond to user product desires, user shopping interest, as well as general user demographic information (which could also be retrieved from a user profile associated with the user creating the new model).

The illustrative process could suggest several advertisements for the driver to select or reject. This could be a list of advertisements, or it could just be a succession of advertisements played back for user response 211. As the user processes the advertisements, or selects advertisements from a list, the recommender system can learn from the occupant's selection of advertisements and update the selected user model. With time, this system will learn what sorts of advertisements are preferred by a user in a given model 213. Over time, this model should improve continually.

In this embodiment, biometric data can be used to train the selected user model based on biometric response while an ad is playing 215. For example, user pulse reactions, changes in a user facial response, etc., can indicate a user interest in a particular advertisement.

Also, a user may be asked to make several decisions such as: more information, coupon requested, directions to a destination, etc. The answers to the questions can be used to gauge user interest in advertisements and to further train the user selected preference model. Even the mere fact that a user responds to any questions can show that there was at least some level of interest in an advertisement.

Also, a user may be asked to rate one or more advertisements or provide feedback such as “liked,” “not interested,” etc. This could be done through a survey or just a simple question asked after an advertisement runs.

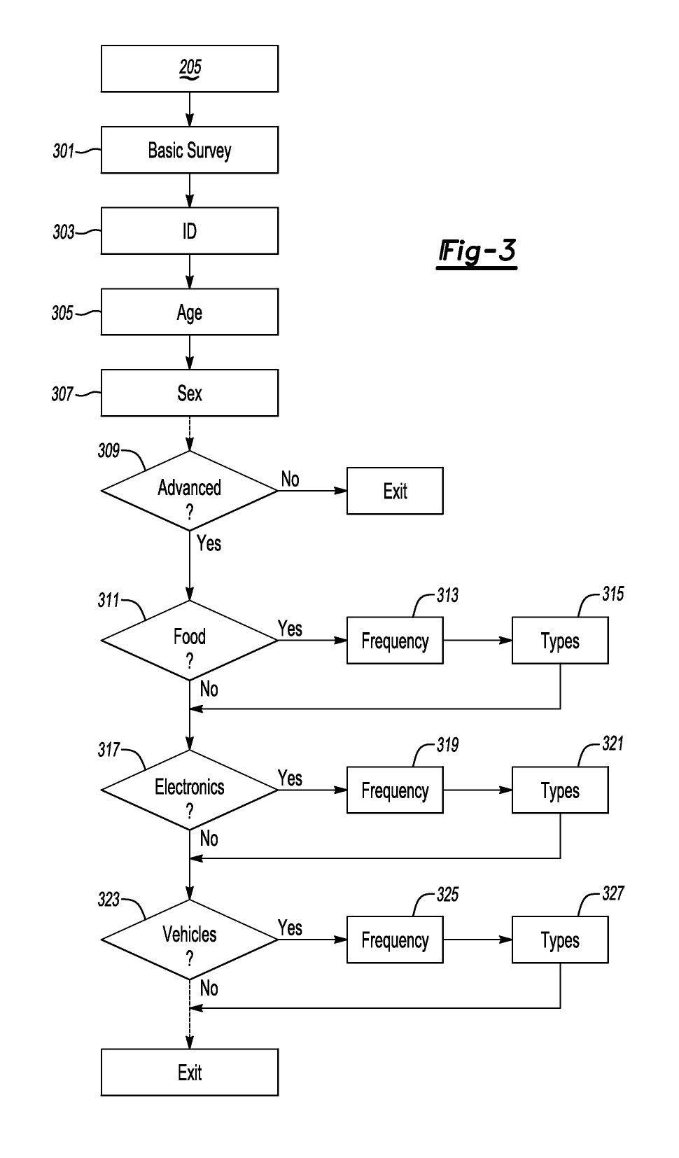

FIG. 3 shows an illustrative process for obtaining user data. In this illustrative example, a general user profile for a specific model is developed. This provides an initial profile for advertisement delivery as the profile learns more about what particular advertisements a user desires. in this illustrative example, the user may complete a basic survey 301 that provides some initial information. This information can be used, especially initially, to determine advertisements that should be presented to a user. The basic information can be used to characterize a user based on general demographic preferences. In this illustrative example, the basic survey includes some user identifier 303, which could be a user name, a user ID, a facial recognition, other bio-specific information, or any other unique identifier.

Also, in this example, the basic survey may request a user age or age range. The system can use the age information to determine an age demographic, for example, usable in general advertisement selection. Similarly, the process may ask for a user sex 305 in order to determine a sex demographic for initial advertisement presentation. Other suitable basic information can be collected to establish a general user profile. This information can include, for example, user race, user income (or income range), an area of the country, a number of kids (or whether the user has kids), etc.

In some instances, a particular user may have already established a basic profile. This profile could be saved locally, on a phone, or remotely. In such a case, the user profile could be uploaded from the stored location to prevent repeated input of common information. Since the advertisement profiles may vary for a given user (e.g., one for a Sunday drive, one for a trip to the store, one for a trip to work), some information may be common to the each profile, while other information may vary based on the type of trip.

In some situations, additional advanced information may be added 309. This could allow the user to input information specifically related to types of preferred advertisements. This information input can speed up advertisement selection and can also aid in developing general profiles for certain demographics on remote servers. For example, the process may as a user if food advertisements are preferred 311. If the user would like to at least occasionally hear food advertisements, the process can then ask how frequently the user would like to hear this sort of advertisements 313. This doesn't have to be a specific percentage, but can be as simple as “sometimes,” “frequently,” etc. Additionally, the user can be asked about the types of food advertisements desired. For example, these could include, but are not limited to, restaurant types (fast food, sit down, etc.), restaurant names (MCDONALDS, WENDYS), or food genres (Italian, Mexican, middle eastern, etc.).

Another possible category for advertisement selection is electronics 317. In this case, the process may again ask about a frequency 319 and then follow up with a types query 321. In this instance, the types may include, for example, without limitation, home electronics, business electronics, PCs, TVs, radios, boat electronics, etc.

Instead of presenting an exhaustive list of yes/no questions for categories, it is also possible to present a user with an item selectable list of possible categories. The user could then select the specific categories desired and be asked the appropriate follow up questions to determine types and selections of advertisements.

These categories, while representative, are not exhaustive. Further, as the system presents more and more advertisements, the process can further refine the specificities associated with user preferences. In some instances, the user may just allow the advertisements to come in organically at first, and rely on the system to refine the particulars of advertisement selection. Once all the suitable refinements of the initial model are completed, the process can begin presenting advertisements and gathering data.

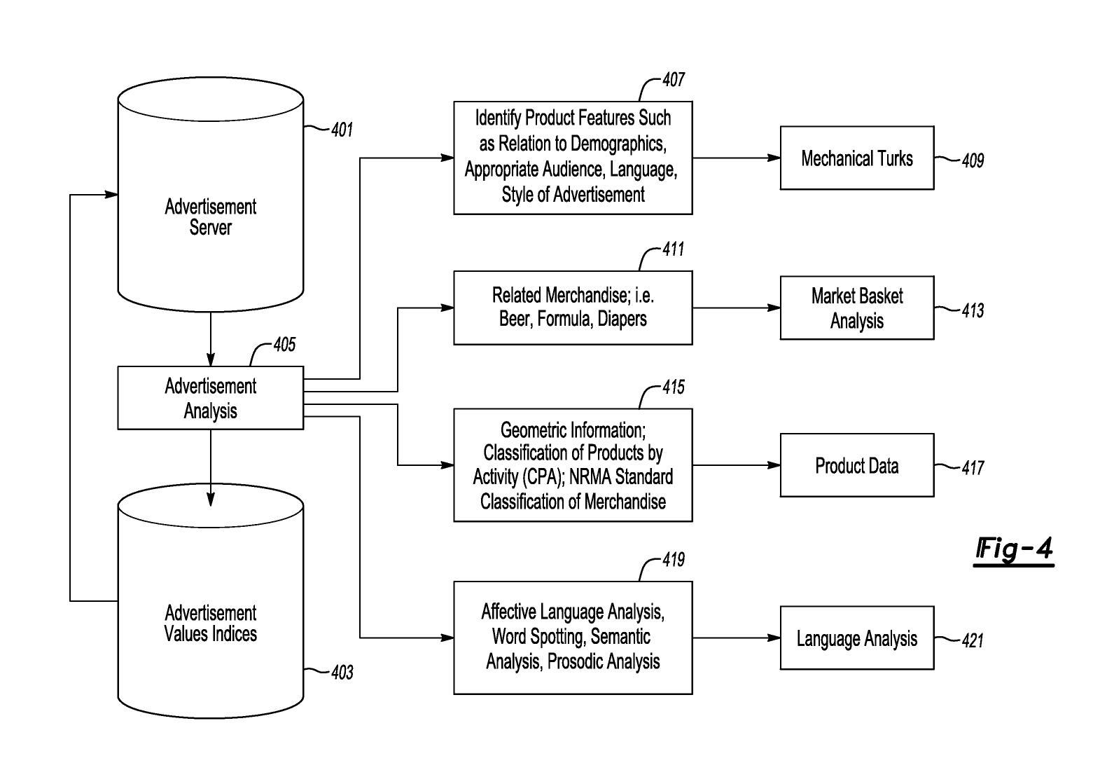

FIG. 4 shows an illustrative exemplary system usable for indexing advertisement information. In this illustrative example, a plurality of databases maintain advertisements and also value indices for the particular advertisements. As data is fed into an analysis processing engine 405, the values indices are updated and this information can be fed back into the advertisement server for association with a particular advertisement.

In this example, the advertisement server(s) can maintain a large number of possible advertisements for presentation to the user. These advertisements can have a number of tags associated therewith, characterizing the advertisements, their length, interactive nature, coupon association, etc. Also, the advertisements may have demographic and rating information associated therewith. For example, advertisements for new televisions may be most commonly associated with males ages 25 to 38. Within those demographics, varying value indices may be associated with the respective ages or age groups. Thus, when a user of a particular age requests an “electronics” advertisement, the particular useful advertisement may be selected based at least partially on these observed values.

The other database 403 may be specifically related to a user or a defined user group. As user or user-group data is processed by the determination algorithm 405, the data in this group may be updated to determine optimal advertisements for presentation. If, for example, the data is kept for a specific user, values can be appropriately decremented for a specific advertisement so that the same advertisement is not played twice in too short of a time. Similarly, the other related advertisements can be decremented, but maybe by a lesser number, so that two advertisements for similar products do not follow one after each other. Other suitable methods of adjusting the values (incrementing unrelated products, locking out related products for at least X instances, etc.) may be applied as fit.

In this example, a number of non-limiting inputs for the analysis engine are also displayed. First, a demographic group defining a user may be one input. In the example shown, the preferred demographics of mechanical (i.e. mechanically oriented) Turkish people are considered 409. These feed in product features known to be associated with this demographic, such as audience, language, style of advertisement, etc. 407

Also, in this example, the process includes market basket analysis 413, for particular products that are preferred by people in a known demographic. This can input otherwise unknown information, such as product types and even merchants preferred.

Another input can include product data 417. This data can include, but is not limited to, classification of products by activity, standard classifications of merchandise, etc. 415. The data can also be compared to a particular user's known preferences for better selection of advertisements. All of the data drawn from these sources can be compared to existing advertisements to determine how those advertisements should be/are characterized or fit desired modeling.

Also, language analysis may be included 421. In this example, the language analysis includes affective language analysis (e.g., what does the driver respond to), word spotting, semantic analysis, prosodic analysis, etc. 419.

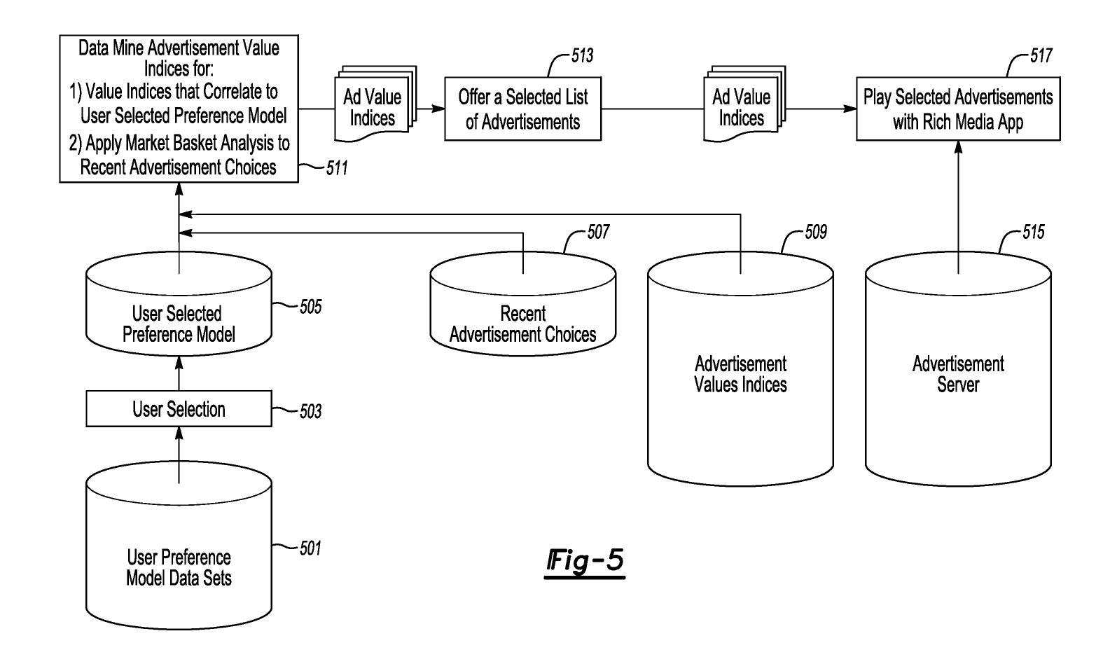

FIG. 5 shows an exemplary process for selecting advertisements. In this illustrative example, the process utilizes a number of varying databases. For example, there may be a user preference model data set 501. This is a specific dataset for a given user, and is a good way (once developed through observation and user input) to deliver highly targeted advertisements to a user. As one possible input source, a user could choose this as a possible usable model for a given drive 503.

Since there may be a number of models for a given user, which correspond to various scenarios, a particular model may be selected for a user 505. In another example, the user may elect to use “known models” and then the process may determine which of the particular models based, for example, on observed context information (weather, time of day, destination, purpose of trip, etc.).

If the user doesn't select a particular model, then, in another example, the process may select advertisement criteria based on recent advertisement choices 507. If a user has been receptive or not receptive to various advertisements recently presented, the system may utilize the responses from this scenario to select advertisements for presentation.

In yet another model, the process may utilize data based on particular demographics 509. The advertisement value indices may be correlated to specific known user demographics, which themselves may be modified and updated in a user profile as more is learned about a particular user.

Once a model or models for usage have been selected, advertisement value indices can be mined to find advertisements that correspond to the model(s) selected 311. It is possible that more than one model is in use, but each should have corresponding weighting and/or values associated with advertisement characteristics, which should allow for selection of reasonably good advertisement choices based on the modeling.

Market basket analysis can be used to further refine the choices, such that advertisements with a high likelihood of user interest are selected. Once the particular advertisements are selected, the user, in this example, can be offered a list of selected advertisements. In another example, the process may simply present a number of advertisements as appropriate and gauge the user response.

Once the appropriate advertisements have been user or machine selected, the process may play the selected advertisements 517, the content for which can be drawn from the advertisement server 515. Although not shown, user responses to these advertisements, along with specific advertisements selected by the user, if that model is implemented, can be used to update the selected models and advertisement indices.

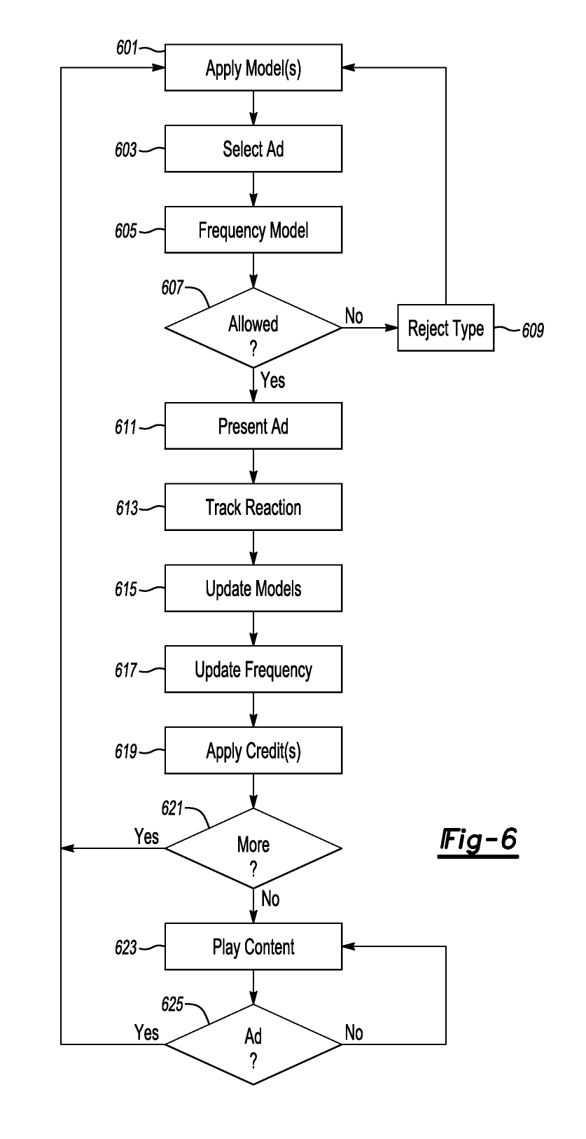

FIG. 6 shows an exemplary process for presenting advertisements and tracking user reactions. In this illustrative example, one or more models are applied 601 prior to advertisement selection. This process, in this example, is “cognizant” of previously presented advertisement types, in accordance with user selected or demographic appropriate categories.

Once a given model is chosen, the process will apply the variables associated with the model(s) to advertisement value indices to determine an appropriate advertisement for presentation 603. Once selected, the advertisement type (or other attribute) is compared against a frequency model 605. Even if a user may want to primarily hear advertisements directed at one or two subjects, it may be counterproductive to repeatedly present a specific advertisement or group of advertisements.

Accordingly, the process may prevent repeated presentation of an advertisement or type of advertisement based on a frequency model. The process may vary based on preferences, for example, in one instance the system may absolutely prevent replay of a similar advertisement type, in another example, the process may only downgrade playback of a similar type, such that if a value associated with the type remains above a threshold (or that of the other advertisements), it may still be selected.

If the advertisement is not allowed 607 based on determinations that a frequency model (or other measure) prevents playback of the advertisement, the process will reject advertisements of that type 609 and return to the modeling process for selection of an advertisement of a differing type.

On the other hand, if the model is accepted, the process will present the advertisement 611 or present a group of selected advertisements for user selection 611. Once the advertisement has been presented, the process may track a user reaction to the advertisement or advertisements 613.

Tracking will result in some data gathering with respect to the various advertisements. Using this data (responsiveness, requests for additional information, user surveys, etc.), the process can update one or more various models 615. Unselected models may also be updated by the process, depending on the relevance of the user response. Merely because a model isn't utilized to provide a particular advertisement, doesn't mean the model cannot benefit from the user response update.

Also, in this exemplary embodiment, the process tracks a frequency of advertisements 617. Using frequency data, the process can update the frequency model to help ensure that advertisements aren't repeated, based on specific advertisements or types. Also, in this model, any credits that accrue to a user are applied 619. For example, a user may be required to listen to four advertisements, or, for example, listen and interact with at least two advertisements. Depending on user responses and requirements of a system, any credit a user obtains for interactions or listening can be reported here.

After the appropriate metrics have been adjusted, the process can determine if there are more advertisements to be played in a current advertisement block 621 or if the content playback should continue 623. If the advertisements are complete, the content playback continues 623 until such time as the process determines that another advertisement should be played 625.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
initiate a new user-model for advertising evaluation based on a user request;
add basic user demographic information to the model;
update the model based on user responses to advertisements presented during a drive in which the model is in use; and
utilize the model to filter or select advertisements in drives having some correspondence to identifying traits associated with the model.

2. The system of claim 1, wherein the processor is further configured to query a user to obtain the basic user demographic information.

3. The system of claim 1, wherein the processor is further configured to obtain the basic user demographic information from previously stored user demographic information.

4. The system of claim 1, wherein the updating includes increasing or decreasing a user-desirability characteristic of an advertisement category based on respective positive or negative user response.

5. The system of claim 1, wherein the identifying traits include a specified destination.

6. The system of claim 1, wherein the identifying traits include a time of day.

7. The system of claim 1, wherein the identifying traits include a day of week.

8. A computer-implemented method comprising:
initiating a new user-model for advertising evaluation based on a user request;
adding basic user demographic information to the model;
updating the model based on user responses to advertisements presented during a drive in which the model is in use; and
utilizing the model to filter or select advertisements in drives having some correspondence to identifying traits associated with the model.

9. The method of claim 8, further including querying a user to obtain the basic user demographic information.

10. The method of claim 8, further including obtaining the basic user demographic information from previously stored user demographic information.

11. The method of claim 8, wherein the updating includes increasing or decreasing a user-desirability characteristic of an advertisement category based on respective positive or negative user response.

12. The method of claim 8, wherein the identifying traits include a specified destination.

13. The method of claim 8, wherein the identifying traits include a time of day.

14. The method of claim 8, wherein the identifying traits include a day of week.

15. A non-transitory computer-readable storage medium storing instructions that, when executed by a processor, cause the processor to perform a method comprising:
initiating a new user-model for advertising evaluation based on a user request;
adding basic user demographic information to the model;
updating the model based on user responses to advertisements presented during a drive in which the model is in use; and
utilizing the model to filter or select advertisements in drives having some correspondence to identifying traits associated with the model.

16. The storage medium of claim 15, wherein the method further includes querying a user to obtain the basic user demographic information.

17. The storage medium of claim 8, wherein the method further includes obtaining the basic user demographic information from previously stored user demographic information.

18. The storage medium of claim 8, wherein the identifying traits include a specified destination.

19. The storage medium of claim 8, wherein the identifying traits include a time of day.

20. The storage medium of claim 8, wherein the identifying traits include a day of week.
